(19) United States
(12) Patent Application Publication
(10) Pub. No.: US 2003/0008104 A1
(43) Pub. Date: Jan. 9, 2003

(54) Freely strecthable three dimensional packaging sheet

(76) Inventor: Jack Chang, Taipei City (TW)

Correspondence Address: Jack CHANG, PO Box 82-144, TAIPEI, TW

(21) Appl. No.: 09/899,251

(22) Filed: Jul. 6, 2001

(51) Int. Cl. B32B 3/10

(52) U.S. Cl. 428/131

(57) ABSTRACT

A freely stretchable three dimensional packaging sheet includes a plurality of elongated members made of recycled material which curves in a continuous corrugated fashion, wherein each of the elongated members has a plurality of equidistant knots which meet at innermost curving portion, a first one of the elongated members is affixed to a second one of the elongated members so that the knots of the first and second elongated members are joined together, the second one and a third one of the elongated members being joined at their intermediate, outermost curved portions such that the intermediate portion between two knots of the second one of the elongated member is joined to intermediate portion of two knots of the third one of the elongated members, and this pattern of joining thereafter repeats, whereby the packaging sheet can be recycled and is easy for transportation and storage.

### BACKGROUND OF THE INVENTION

1. Field of the Invention

This invention is related to a freely stretchable three dimensional packaging sheet and in particular to one which is made of recycled material so that it can be recycled again after use thereby complying with the environmental protection requirements.

2. Description of the Prior Art

It has been found that polystyrene foam and plastic bubble sheeting are commonly used for packaging to protect products therein. However, polystyrene foam and plastic bubble sheeting cannot be recycled thereby causing environment problems. Therefore, developed countries have begun to prohibit the use of materials which do not meet their environmental protection requirements. Although such kinds of polystyrene foam and bubble sheeting material can be decomposed of by burning, the disposal coat is ten times the amount of its production, and it is therefore uneconomical. In addition, the bubble sheeting is bulky in volume, making it difficult to transport and store.

Therefore, it is an object of the present invention to provide a freely stretchable three dimensional packaging sheet which can obviate and mitigate the above-mentioned drawbacks.

### SUMMARY OF THE INVENTION

This invention is related to freely stretchable three-dimensional packaging sheet.

It is the primary object of the present invention to provide a freely stretchable three-dimensional packaging sheet which can be recycled again after use thereby complying with the environmental protection.

It is another object of the present invention to provide a freely stretchable three-dimensional packaging sheet which is compact when not in use thereby facilitating the transportation and storage.

It is still another object of the present invention to provide a freely stretchable three-dimensional packaging sheet which can be stretched to provide an area which is 40 times as much as its original area.

It is still object of the present invention to provide a freely stretchable three-dimensional packaging sheet which enables one to watch the article enclosed therein without removing the packaging sheet.

It is a further object of the present invention to provide a freely stretchable three-dimensional packaging sheet which enables light and air to pass therethrough thus making it especially suitable for packaging articles which requires ventilation.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention;

FIG. 2 illustrates the present invention arranged in a roll;

FIG. 3 illustrates the present invention folded in a container;

FIG. 4 illustrates how the present invention is used for packaging a jar; and

FIG. 5 illustrates how the jar packaged by the present invention is put into a container.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

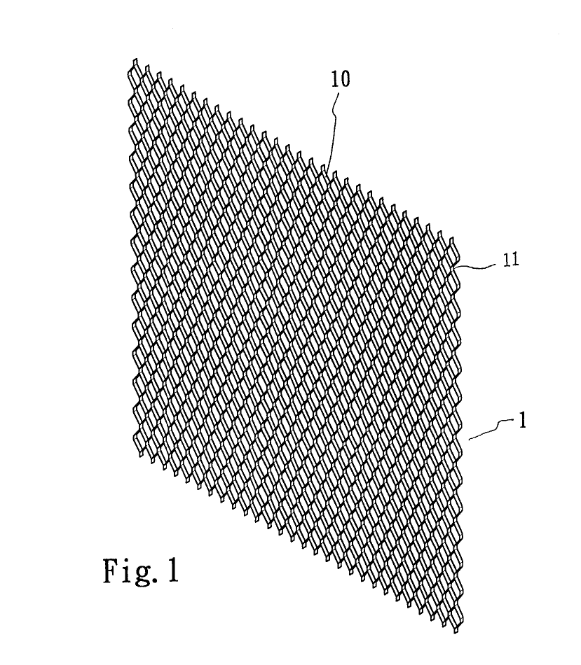

Referring to FIG. 1, the freely stretchable three-dimensional packaging sheet according to the present invention generally is made of recycled material 1 and comprises a plurality of elongated members 10 with the same width which curve in a continuous corrugated fashion. Each of the elongated members 10 has a plurality of equidistant knots 11 which meet at the innermost curving portion of the elongated members 11. The first elongated member 10 is affixed to the second elongated member 10 so that the knots 11 of the first and second elongated members 10 are joined together. The second and third elongated members are joined at their intermediate, outermost curved portions such that the intermediate portion between two knots 11 of the second elongated member 10 is joined to the intermediate portion of two knots 11 of the third elongated member 10. This pattern of joining thereafter repeats, wherein every two members will join at the knots 11; and the second of the every two members will join the following elongated member at the intermediate portion between the knots 11, thereby forming a packaging net.

The elongated members 10 are closely arranged together when not in use and may be stretched to form a net-like member as shown in FIG. 1 for packaging purposes. The packaging sheet according to the present invention can be stretched to provide an area which is 40 times as much as its original area.

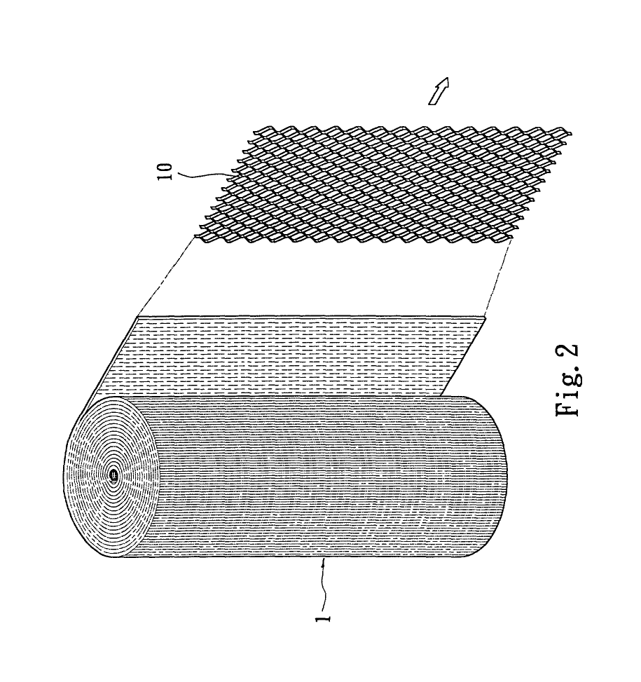

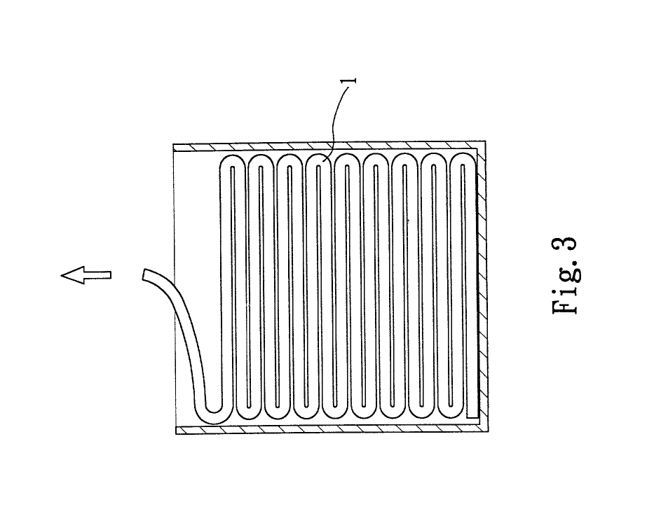

The elongated members 10 are arranged in a collapsed condition so that the packaging sheet can be arranged in a roll (see FIG. 2) or put in a container (see FIG. 3) thereby facilitating the transportation and storage thereof. The packaging sheet can be stretched to form a three-dimensional member for packaging an article. As the packaging sheet according to the present invention can be of an unlimited length, the size of the packaging sheet can be obtained as desired.

The strength of the packaging sheet depends on the strength of the material for making the elongated member 10, the thickness of the elongated member 10, and the distance between two adjacent knots of the elongated member 10.

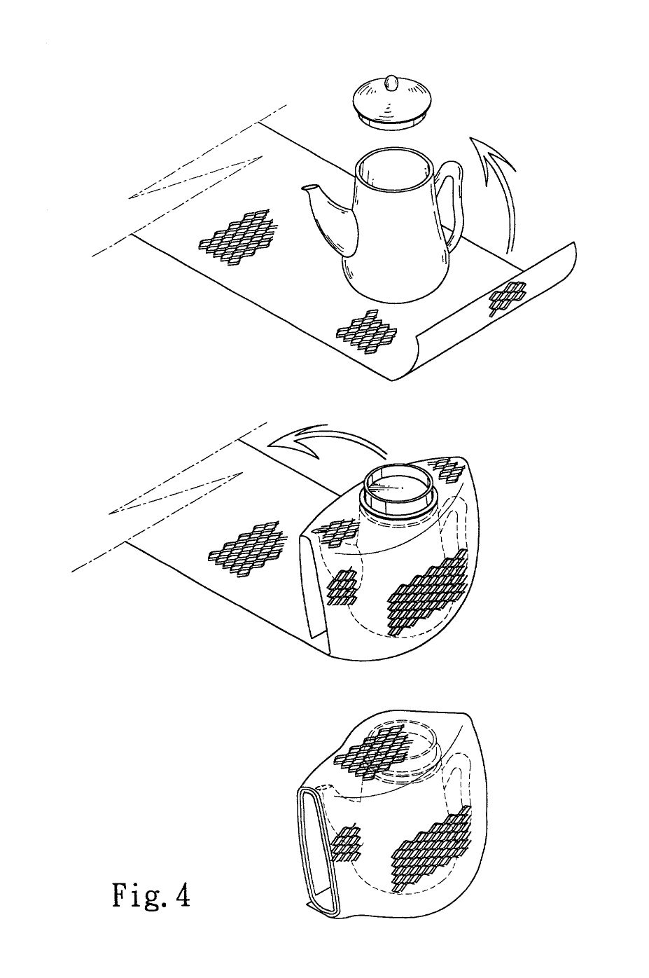

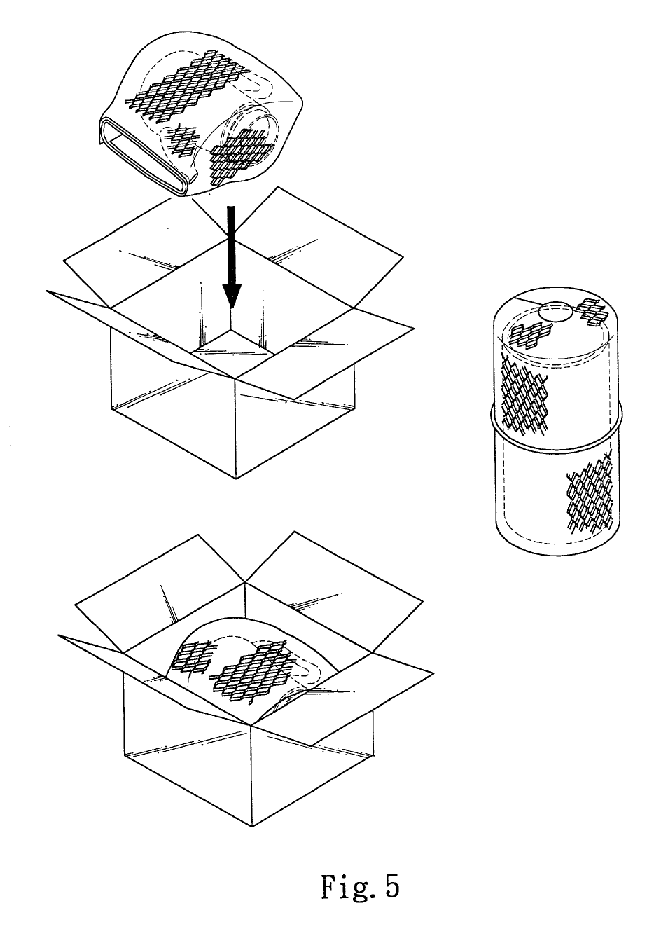

FIG. 4 illustrates how to use the packaging sheet according to the present invention to package a jar. As shown, the packaging sheet according to the present invention not only can be used for packaging the jar, but also for providing the jar with an aesthetic packaging. Then, the jar enclosed with the packaging sheet can be put inside a box for facilitating transportation (see FIG. 5).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A freely stretchable three dimensional packaging sheet comprising a plurality of elongated members made of recycled material and having same width and curving in a continuous corrugated fashion, each of said elongated members having a plurality of equidistant knots which meet at innermost curving portion of said elongated members, a first one of said elongated members being affixed to a second one of said elongated members so that said knots of said first and second elongated members are joined together, said second one and a third one of said elongated members being joined at their intermediate, outermost curved portions such that said intermediate portion between two knots of said second one of said elongated member is joined to intermediate portion of two knots of said third one of said elongated members, and this pattern of joining thereafter repeats, wherein every two of said elongated members will join at said knots, and said every two of said elongated members will join following elongated member at the intermediate portion between the knots thereby forming a packaging net.
